(19) United States
(12) Patent Application Publication
(10) Pub. No.: US 2003/0037070 A1
(43) Pub. Date: Feb. 20, 2003

(54) Streaming media security system

(75) Inventor: Eric E. Marston, Ventura, CA (US)

Correspondence Address: Brian M. Berliner, O'MELVENY & MYERS LLP, 400 South Hope Street, Los Angeles, CA, 90071-2899, US

(73) Assignee: FIRSTLOOK.COM.

(21) Appl. No.: 09/921,613

(22) Filed: Jul. 31, 2001

(51) Int. Cl. G06F 7/00

(52) U.S. Cl. 707/200

(57) ABSTRACT

A streaming media security system provides for delivery to users of an encrypted URL identifying the address of a desired streaming media file. More particularly, the system receives a request from a user via the network to deliver a desired streaming media file. The system retrieves a uniform resource locator (URL) corresponding to the desired streaming media file from a database. The system then encrypts the URL, and embeds the encrypted URL within a Hyper Text Markup Language (HTML) document linking the user to the desired streaming media file. The HTML document is then delivered to the user via the network. Upon receipt of a request from the user for the encrypted URL, the system delivers the desired streaming media file to the user. In an embodiment of the invention, the encrypted URL further includes a time-based token that identifies the time when the original user request for the streaming media file was received. Upon receipt of a subsequent request from the user for the encrypted URL, the system checks the time-based token to determine whether a pre-determined time has elapsed. If the pre-determined time has not elapsed, the system delivers the desired streaming media file to the user. But, if the pre-determined time has elapsed, the system does not deliver the desired streaming media file to the user.

### BACKGROUND OF THE INVENTION

1. Field of the Invention

The present invention relates to a method and apparatus for delivering streaming media in a computer network. More specifically, this invention relates to a method and apparatus for delivering streaming media to users in a secure manner that prevents subsequent retrieval of such media by unauthorized users.

2. Description of Related Art

For many years, the global retail market for audio and video content has been characterized as a market in which physical products (e.g., audio/video cassettes, compact disks (CD), digital video disks (DVD), etc.) are sold from physical locations. In recent years, however, this dynamic has undergone a significant change in response to the increasing popularity of the Internet and in particular with the increasing availability of broadband connectivity enabling delivery of high quality audio and video content over the Internet. It should be appreciated that the Internet is defined here as a collection of interconnected (public and/or private) networks linked together by a set of standard protocols (such as TCP/IP and HTTP) to form a global, distributed network. While this term is intended to refer to what is now commonly known as the Internet, it is also intended to encompass variations that may be made in the future, including changes and additions to existing standard protocols.

More particularly, the transmission of audio and video content over a data network is generally known as “streaming”. In a streaming media broadcast, the audio and/or video content is broken into data packets that are routed from a server to the end user (or client) for reconstruction into a stream of audio or video data. The audio and video streams then appear to the end user as a continuous broadcast similar to that experienced with a conventional radio or television broadcast. To reliably deliver streaming video content, both the client and server software must cooperate so that the video motion appears uninterrupted. The client side buffers a few seconds of audio and/or video data before it starts sending it to the computer screen, which compensates for momentary delays in packet delivery. Thus, streaming audio or video implies a one-way transmission and is generally tolerant of erratic networks.

Many Internet websites are supported by business models that rely heavily, if not entirely, on revenue generated from the delivery of audio and video streams to end users. For example, a website operated by the assignee of the present patent application, www.firstlook.com, provides previews of new music, movies, television, and video games in a streaming audio/video format. A drawback of providing such websites is the relatively high cost of delivering audio and video content due in part to the server capacity and amount of bandwidth that is required to provide the streams. Hence, businesses that provide streaming audio and video need to make sure that their assets are not accessed without their permission. Currently, when a user initiates a request for a particular stream from such a website, the uniform resource locator (URL) for that stream is embedded in a page that is delivered to the user. While most users would not ordinarily notice the URL, sophisticated Internet users can readily see the URL by viewing the HTML code defining the page using tools available in most Internet browser applications. An unscrupulous user could then copy the URL for the stream for later use, such as by linking to the URL from another website. The user could then access the stream again in the future without visiting the originating website, which would deprive the originating website of revenue generating opportunities. The business that operates the originating website would nevertheless have to pay for that subsequent usage. This improper usage of the streaming media by copying the URL in this manner is commonly referred to in the art as “URL hijacking.”

A need therefore exists for a way to enable websites that deliver streaming media to prevent their URL's from being hijacked by unscrupulous users. More specifically, the URL should be delivered to the user in a secure form that deters copying and that would prevent subsequent access of the stream if the URL was copied.

### SUMMARY OF THE INVENTION

A streaming media security system provides for delivery to users of an encrypted URL identifying the address of a desired streaming media file. More particularly, the system receives a request from a user via the network to deliver a desired streaming media file. The system retrieves a uniform resource locator (URL) corresponding to the desired streaming media file from a database. The system then encrypts the URL, and embeds the encrypted URL within a Hyper Text Markup Language (HTML) document linking the user to the desired streaming media file. The HTML document is then delivered to the user via the network. Upon receipt of a request from the user for the encrypted URL, the system delivers the desired streaming media file to the user.

In an embodiment of the invention, the encrypted URL further includes a time-based token that identifies the time when the original user request for the streaming media file was received. Upon receipt of a subsequent request from the user for the encrypted URL, the system checks the time-based token to determine whether a pre-determined time has elapsed. If the pre-determined time has not elapsed, the system delivers the desired streaming media file to the user. But, if the pre-determined time has elapsed, the system does not deliver the desired streaming media file to the user.

A more complete understanding of the streaming media security system will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a block diagram illustrating a streaming media security system in accordance with an embodiment of the present invention; and

FIG. 2 is a flow chart illustrating operation of the streaming media security system.

### DETAILED DESCRIPTION OF THE PREFERRED EMBODIMENT

The present invention satisfies the need for a way to enable websites that deliver streaming media to prevent their URL's from being hijacked by unscrupulous users. More specifically, the streaming media security system delivers an encrypted URL to the user that further includes a time-based token. The encrypted URL is used to retrieve a desired stream from the website. Unlike a conventional URL, the encrypted URL will only be valid for a limited period of time relative to the time defined in the time-based token. After the time period has expired, the URL will no longer be effective to retrieve an associated stream.

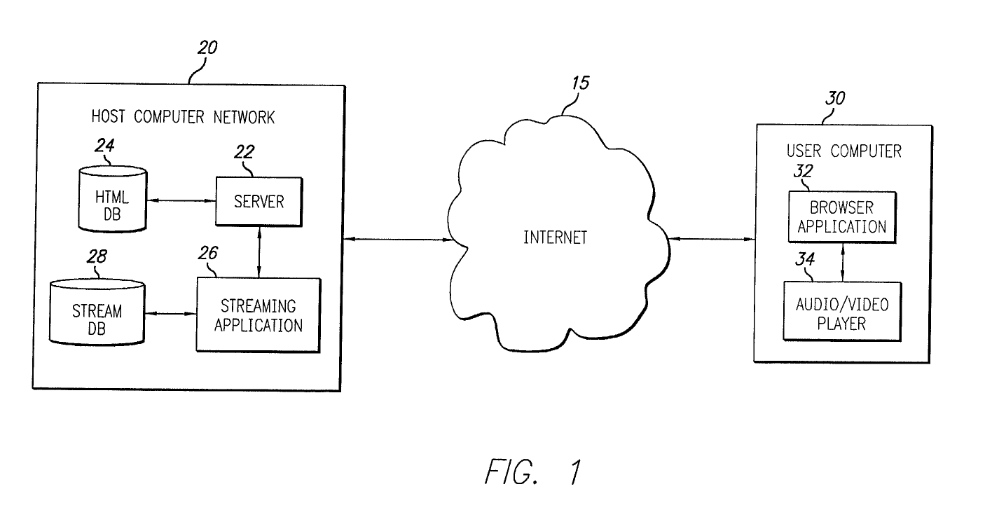

In FIG. 1, a block diagram is illustrated of a wide area network employing a method and apparatus according to an embodiment of the invention. It is anticipated that the present invention operates with a plurality of computers which are coupled together on a wide area network, such as the Internet 15, or other communications network. As illustrated, a host computer network 20 is shown to communicate with user computers 30 via the Internet 10. It should be appreciated that user computers 30 may include any type of computing device that allows a user to interactively browse websites, such as a personal computer (PC) that includes a Web browser application 32 (e.g., Microsoft Internet Explorer™ or Netscape Communicator™). Suitable user computers 30 equipped with browser applications 32 are available in many configurations, including handheld devices (e.g., PalmPilot™), personal computers (PC), laptop computers, workstations, television set-top devices, multi-functional cellular phones, and so forth. In the following description, it should be further appreciated that user computers 30 are defined herein as computers equipped with an audio/video player 34 (e.g., Microsoft Media Player™) as illustrated in FIG. 1.

The host computer network 20 is further comprised of a streaming application 26 coupled to a streaming database 28 and a Web server 22 connected to an HTML (Hyper-Text Markup Language) documents database 24. As is also generally known in the art, Web server 22 accesses a plurality of Web pages, distributable applications, and other electronic files containing information of various types stored in HTML document databases 24. HTML documents are then delivered by the Web server 22 via the Internet 15 to the user computer 30 for display using the browser application 32 as a Web page. The HTML document may be communicated in the form of plural message packets as defined by standard protocols, such as the Transport Control Protocol/Internet Protocol (TCP/IP). It should be appreciated that many different user computers, many different Web servers, and many different search servers of various types may be communicating with each other at the same time.

It should be further appreciated that a user identifies a Web page that is desired to be viewed at the user computer 30 by communicating an HTTP (Hyper-Text Transport Protocol) request from the browser application 32. The HTTP request includes the Uniform Resource Locator (URL) of the desired Web page, which may correspond to an HTML document stored in the HTML documents databases 24. The HTTP request is then routed to the Web server 22 via the Internet 15. The Web server 22 then retrieves the HTML document identified by the URL, and communicates the HTML document across the Internet 15 to the browser application 32.

In a preferred embodiment of the invention, a host computer network 20 delivers a streaming media broadcast directly linked from a particular Web page within a network. These Web pages are further comprised of HTML code having an encrypted URL and an embedded time-based token for all streaming media broadcasts within the streaming database 28. This encrypted URL is then used by the host computer network 20 to link the user computer 30 to the appropriate streaming broadcast directly from the website. In a preferred embodiment, the encrypted URL will only be valid for a limited period of time relative to the time defined by the time-based token. Unlike a conventional URL, however, this encrypted URL will no longer be able to retrieve an associated stream after this pre-defined time period has expired.

A better appreciation for the URL implementation described in the present invention may be attained by comparing conventional HTML code used for linking users to streaming media with the partially encrypted HTML code described here. Normally the exemplary HTML code for a Web page with an embedded media stream will resemble the following:

<table border=0 cellpadding=0 cellspacing=0 bgcolor=“”>

<tr>

<td valign=“middle” align =“center” bgcolor=“”>
<table border=0 cellspacing=“0” cellpadding=“0” bgcolor=“”>
<tr>

<td align=“center” bgcolor=“”>
<OBJECT ID=“MediaPlayer”
classid=“CLSID:22d6f312-b0f6-11d0-94ab-0080c74c7e95”

CODEBASE=“http://activex.microsoft.com/activex/controls/mplayer/en/ns

mp2inf.cab#Version=6,4,5,715”

standby=“Loading Microsoft Windows Media Player

components...”

| TYPE=“application/x-oleobject”> | |
|---|---|
| <PARAM | NAME=“FileName” |

VALUE=“http://www.firstlook.com/streaming/v_planet_apes_500.asx”>

<PARAM NAME=“AnimationatStart” VALUE=“true”>
<PARAM NAME=“TransparentatStart” VALUE=“true”>
<PARAM NAME=“AutoStart” VALUE=“true”>
<PARAM NAME=“ShowControls” VALUE=“0”>
<embed TYPE=“application/x-mplayer2”

pluginspage=“http://www.microsoft.com/isapi/redir.dll?prd=windows&sbp=

mediaplayer&ar=Media&sba=Plugin&”

SRC=“http://www.firstlook.com/streaming/v_planet_apes_500. asx”

Name=MediaPlayer

SHOWCONTROLS=0

height=‘272’ width =‘592’
AutoStart=true
</embed>
</OBJECT></td>

</tr>
</table></td>

</tr>

</table>

In the exemplary HTML code provided above, the embedded URL (i.e., http://www.firstlook.com/streaming/v_planet_apes_{—}500.asx) provides the address for a media stream for a movie trailer for the film “Planet of the Apes.” It should be appreciated that the URL exposed and can thus be obtained by anyone. As a result, this URL may simply be copied from the HTML code in order to retrieve the media stream while bypassing linking to this particular Web page from the host computer network 20.

In a preferred embodiment, the URL for an embedded media stream is encrypted within the HTML code for the host Web page. By way of example, the HTML code for Web pages embedded with media streams may therefore resemble the following:

<table border=0 cellpadding=0 cellspacing=0 bgcolor=“”>

<tr>

<td valign=“middle” align=“center” bgcolor=“”>
<table border=0 cellspacing=0 cellpadding=“0” bgcolor=“”>
<tr>

<td align=“center” bgcolor=“”>
<OBJECT ID=“MediaPlayer”
classid=“CLSID:22d6f312-b0f6-11d0-94ab-0080c74c7e95”

CODEBASE=“http://activex.microsoft.com/activex/controls/mplayer/en/ns

mp2inf.cab#Version=6,4,5,715”

standby=“Loading Microsoft Windows Media Player

components...”

| TYPE=“application/x-oleobject”> | |
|---|---|
| <PARAM | NAME=“FileName” |

VALUE=“http://www.firstlook.com/streamingsecurity?url=aHR0cDovL3d3dy5maX
JzdGxvb2suY29tL3N0cmVhbWluZy92X3BsYW5ldF9hcGVzXzUwMC5hc3g/Y29
CcmFuZD1tYioqfDk5MzE1OTUxODk4NSoqfA==.asx”>

<PARAM NAME=“AnimationatStart” VALUE=“true”>
<PARAM NAME=“TransparentatStart” VALUE=“true”>
<PARAM NAME=“AutoStart” VALUE=“true”>
<PARAM NAME=“ShowControls” VALUE=“0”>
<embed TYPE=“application/x-mplayer2”

pluginspage=“http://www.microsoft.com/isapi/redir.dll?prd=windows&sbp=

mediaplayer&ar=Media&sba=Plugin&”

SRC=“http://www.firstlook.com/streamingsecurity?url=aHR0cDovL3d3dy5

maXJzdGxvb2suY29tL3N0cmVhbWluZy92X3BsYW5ldF9hcGVzXzUwMC5hc3g/
Y29CcmFuZD1tYioqfDk5MzE1OTUxODk4NSoqfA==.asx”

Name=MediaPlayer
ShowControls=0
height=‘272’ width=‘592’
AutoStart=true
</embed>
</OBJECT></td>

</tr>
</table></td>

</tr>

</table>

In the exemplary HTML code, the embedded URL for the media stream (http://www.firstlook.com/streamingsecurity?url=aHR0cDovL3d3dy5maXJzdGxvb2suY2 9tL3N0cmVhbWluZy92X3BsYW5ldF9hcGVzXzUwMC5hc3g/Y29CcmFuZD1tYioqfDk5 MzE1OTUxODk4NSoqfA==.asx) refers to the address of the same movie trailer as described above in the preceding example. Unlike the preceding example, the embedded URL contains an unencrypted part and an encrypted part. The encrypted part identifies the media stream, but is not readable due to the encryption. Thus, a user may not be inclined to copy the embedded URL simply because one cannot readily determine from an inspection of the URL as to what content it refers. The encrypted part also includes a time-based token. The use and operation of these aspects of the embedded URL will be further understood from the following description.

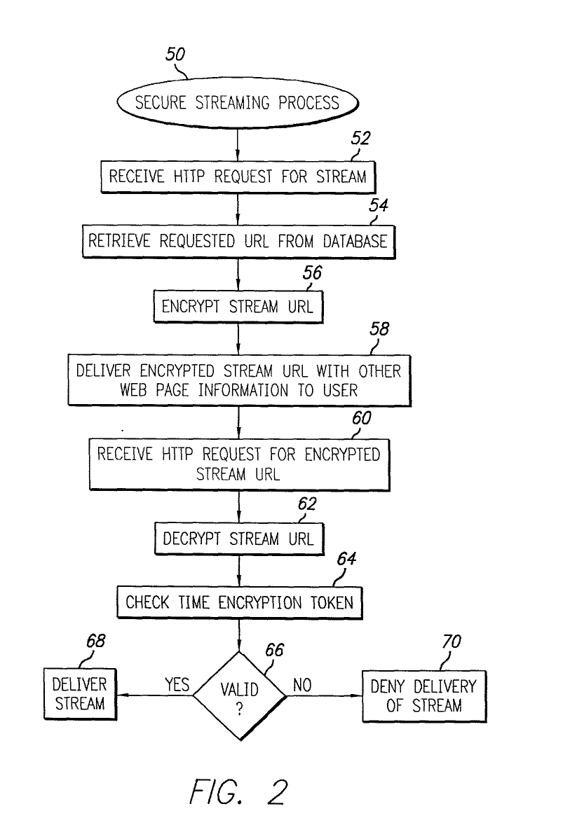

Referring now to FIG. 2, a flow chart showing a secure streaming process 50 operable on the host computer network 20 according to a preferred embodiment of the invention is provided. This process begins at step 52 with the host computer network 20 receiving an HTTP request for a particular media stream from the user computer system 30. The media stream URL pertaining to this HTTP request is then retrieved by the host computer network 20 from within the media stream database 28 at step 54. After retrieving the requested media stream URL, the host computer network encrypts the URL using an internal encryption algorithm at step 56. The encrypted URL is then integrated into the HTML code for the host Web page in the form described above, and is delivered to the user computer 30 at step 58. It should be appreciated that any of several encryption methods commonly known in the art may be used to encrypt the URL.

As discussed above, the encrypted media stream URL also includes an encrypted time-based token that uniquely identifies when the URL was retrieved from the database 28. This time-based token provides added security against URL hijacking because, unlike a conventional URL, the encrypted URL will only be valid for a limited period of time relative to the time pre-defined in the time-based token. After this time period has expired, the encrypted URL will no longer be effective to retrieve the associated media stream. As a result, any unauthorized link to this media stream created by simply copying the encrypted URL onto the HTML code of another Web page will only be effective for a limited period of time.

Returning to the flow chart provided in FIG. 2, the process continues at step 60 with the host computer network 20 receiving an HTTP request from the user computer 30 for the encrypted URL. Once this request is received, the host computer network 20 decrypts the contents of the URL at step 62. The decrypted time-based token is then extracted from the URL at step 64 in order to determine its validity at step 66. If, at step 66, it is determined that the token is indeed valid (i.e., not expired), then the associated media stream is delivered to the user computer 30 at step 68; otherwise, access to this media stream is denied to the user at step 70.

Having thus described a preferred embodiment of a streaming media security system, it should be apparent to those skilled in the art that certain advantages have been achieved. It should also be appreciated that various modifications, adaptations, and alternative embodiments thereof may be made within the scope and spirit of the present invention. The invention is further defined by the following claims.

What is claimed is:

1. A method for providing streaming media in a computer network, comprising:
receiving a request from a user via said network to deliver a desired streaming media file;
retrieving a uniform resource locator (URL) corresponding to the desired streaming media file;
encrypting the URL;
embedding the encrypted URL within a Hyper Text Markup Language (HTML) document linking said user to said desired streaming media file;
delivering the HTML document to the user via said network;
receiving a request from said user for the encrypted URL; and
delivering said desired streaming media file to the user.

2. The method of claim 1, wherein said embedding step further comprises embedding a time-based token within said HTML document.

3. The method of claim 2, wherein said step of delivering said desired streaming media file further comprises determining whether a pre-determined period of time has elapsed and delivering said desired streaming media file only if said pre-determined period of time has not elapsed.

4. The method of claim 1, further comprising maintaining a database of plural streaming media files.

5. A system for providing streaming media, comprising:
a host computer coupled to a network and being operable to provide the functions of:
receiving a request from a user via said network to deliver a desired streaming media file;
retrieving a uniform resource locator (URL) corresponding to the desired streaming media file;
encrypting the URL;
embedding the encrypted URL within a Hyper Text Markup Language (HTML) document linking said user to said streaming media file;
delivering the HTML document to the user via said network;
receiving a request from said user for the encrypted URL; and
delivering said desired streaming media file to the user.

6. The system of claim 5, wherein said embedding function further comprises embedding a time-based token within said HTML document.

7. The system of claim 6, wherein said function of delivering said desired streaming media further comprises determining whether a pre-determined period of time has elapsed and delivering said desired streaming media file only if said pre-determined period of time has not elapsed.

8. The system of claim 5, further comprising a database of plural streaming media files.
